(19) United States
(12) Patent Application Publication
(10) Pub. No.: US 2012/0119545 A1
(43) Pub. Date: May 17, 2012

(54) FLOOR STRUCTURE OF AN AUTOMOBILE BODY

(75) Inventors: Udo MILDNER, Limburg (DE); Stanislaw KLIMEK, Frankfurt/Main (DE); Karsten BOHLE, Bad Schwalbach (DE)

(73) Assignee: GM GLOBAL TECHNOLOGY OPERATIONS LLC, Detroit, MI (US)

(21) Appl. No.: 13/294,217

(22) Filed: Nov. 11, 2011

(30) Foreign Application Priority Data
Nov. 12, 2010 (DE) 10 2010 051 270.2

(51) Int. Cl. B62D 25/20

(52) U.S. Cl. 296/193.07

(57) ABSTRACT

A floor structure is provided for an automobile body that includes, but is not limited to a floor panel and a seat support structure disposed underneath the floor panel. The floor panel includes, but is not limited to at least two floor sections that adjoin one another in the vehicle longitudinal direction and are configured to be substantially flat, which are disposed offset with respect to one another in relation to the vehicle vertical direction. The seat support structure has at least one transverse structure stabilizing the floor section at least in the area of the higher floor section.

### CROSS-REFERENCE TO RELATED APPLICATION

This application claims priority to German Patent Application No. 102010051270.2, filed Nov. 12, 2010, which is incorporated herein by reference in its entirety.

### TECHNICAL FIELD

The technical field relates to a floor structure of an automobile body comprising a floor panel and a seat support structure disposed below the floor panel for fastening vehicle seats to the floor structure.

### BACKGROUND

In automobile body construction, there are various concepts for implementing a floor structure to be provided in particular in the area of a passenger compartment of the automobile. Known floor structures comprise a central tunnel extending almost over the entire length of the passenger compartment and running centrally over the floor structure and seat cross members provided separately for fastening vehicle seats, which are disposed on the upper side of a floor panel. The actual floor panel is here usually configured to be multi-part and for example, laterally adjoins the central tunnel with individual floor panel segments.

Other concepts, as described for example in DE 100 18 900 A1 provide a floor panel forming the main floor and extending between a front and a rear face wall of the passenger compartment, which adjoins a tunnel passing lengthwise through the interior of the passenger compartment. The tunnel here is configured as a one-piece tunnel shell which is curved in an arcuate manner when viewed in cross-section and which delimits the tunnel cavity laterally and at the top, which can be mounted as an attachment part on the upper side of the main floor of the floor panel. Accordingly, the floor panel delimits the hollow cross-section of the tunnel toward the bottom, where it is further configured to be flat on its underside over the entire width of the main floor.

Central tunnel structures passing through the entire vehicle floor in the vehicle longitudinal direction on the one hand delimit the useable foot well for the back-seat passengers of an automobile. Furthermore, a separate fastening of a central tunnel on the vehicle floor is relatively complex from the manufacturing and assembly technology viewpoint. In addition, floor panels configured in several parts have the disadvantage that in order to form a closed floor structure, they must be fastened so that they overlap with one another at least in some areas. Material doublings to be provided for this purpose in the connection region of individual floor panel sections contribute to an increase in the vehicle weight.

It is therefore at least one object to provide an improved floor structure for an automobile body that enables simple and cost-effective production and assembly on the one hand and contributes toward a reduction in the vehicle weight on the other hand. In addition, at least another object to provide the floor structure that enables efficient utilization of the installation space available in the floor area of the automobile. For example, accommodating further functional parts and vehicle components in a space-saving manner and should further form a torsionally rigid and warp-resistant supporting structure, in particular for the vehicle seats to be fastened on the floor structure. In addition, other objects, desirable features, and characteristics will become apparent from the subsequent summary and detailed description, and the appended claims, taken in conjunction with the accompanying drawings and this background.

### SUMMARY

Accordingly, a floor structure of an automobile body is provided that comprises a floor panel and a seat support structure disposed underneath the floor panel. The floor panel in turn comprises two floor sections that adjoin one another in the vehicle longitudinal direction (x) and are configured to be substantially flat. The adjoining floor sections are disposed offset with respect to one another in relation to the vehicle vertical direction (z). The seat support structure, which is provided for stabilization and for structural reinforcement of the floor structure in the area of a seat fastening, has at least one transverse structure that stabilizes the corresponding floor section at least in the area of the higher of the two floor sections.

Since the floor panel is configured to be elevated at least in the area of a seat fastening and for example, with respect to a foot well section, on the one hand a seat support structure can be relocated in an area below the floor panel. On the other hand, as a result of a relocation of the floor panel section located in the area of a seat arrangement upward, additional installation space can be used below the floor panel, possibly by other vehicle components such as, for example, vehicle batteries and fuel tanks.

Such a floor panel configured to be elevated in the area of a seat connection is particularly suitable here for so-called multiple purpose vehicles (MPV) or for sport utility vehicles (SUV) that otherwise have a comparatively large distance between a floor structure and the floor line or tire contact plane. In addition, by elevating the floor section provided for the seat fastening, it can be achieved that the central tunnel only needs to be formed in a front area of the floor panel located in front of the seat fastening. In this respect, the seat fastening section of the floor panel that is configured to be elevated in particular with respect to a foot well section and possibly a foot well area for the back seat passengers located there behind can be configured to be free of a central tunnel so that the foot well available for the back seat passengers can ultimately be enlarged.

According to a first embodiment, the floor panel comprises, in relation to the vehicle longitudinal direction (x), at least one front floor section, a central floor section, and a rear floor section. Of the floor sections, at least the central floor section is configured to be elevated with respect to the front and/or the rear floor section in relation to the vehicle vertical direction (z) or is disposed offset hereto.

The three said floor sections, front, central, and rear floor section, are preferably configured to be substantially flat, although in particular in the front floor section, a central tunnel structure, which interrupts the floor plane, should further be provided. It is advantageous if the front floor section coincides with the foot well of the front passengers, the central floor section coincides with a seat fastening region of the floor structure, and the rear floor structure coincides with a foot well for the rear seat passengers.

In a preferred embodiment, it is further provided that the rear floor section is configured to be elevated compared with the front floor section. At least the rear foot well can be configured to be somewhat elevated compared with the front foot well. By elevating the rear floor section, it can be achieved, for example, that the rear floor section can be configured to be substantially flat and therefore free from a central tunnel in the vehicle transverse direction.

It is furthermore found that if the floor section that is configured to be elevated is formed in one piece with at least one further floor section adjoining hereon in the vehicle longitudinal direction. That is, at least two adjoining floor sections in the vehicle longitudinal direction (x) are formed in one piece and can possibly be formed by suitable embossing of a sheet metal blank. At the same time, it is further possible that all the sections of the floor panel are formed in one part or one piece so that the one-piece floor panel. When viewed in the vehicle longitudinal direction (x), extends from a vehicle face wall as far as a heel plate and/or when viewed in the vehicle transverse direction (y), extends from a left side sill as far as a right side sill.

Such a one-piece configuration of the floor panels can be deemed advantageous for reasons of saving weight since in this case no overlapping regions of the floor panel sections need to be formed for connecting the same. A one-piece floor panel is also found to be definitely advantageous from the assembly technology viewpoint since this is accompanied by a reduction in components. It is self-explanatory that a floor panel formed in one piece, covering almost the entire floor of the passenger compartment can be affixed to the supporting structure of the automobile body with far fewer assembly steps and therefore with a reduced assembly effort.

According to an embodiment, the floor section that is configured to be elevated has a surface structuring that increases or improves its stability. In particular, a plurality of beadings formed, for example, in the vehicle transverse direction can be formed in the elevated floor section. Beadings running approximately in the vehicle transverse direction contribute toward a structural reinforcement of the corresponding floor section in the vehicle transverse direction (y). Notwithstanding or in addition to this, it is furthermore feasible to emboss structure-reinforcing beadings running in the vehicle longitudinal direction (x) in the elevated floor section. It is also feasible to provide a surface-stabilizing beading structure, possibly of hexagonal or diamond-shaped geometry, in particular in the elevated floor section.

For fastening vehicle seats, in particular seat rails running in the vehicle longitudinal direction, which receive the vehicle seats, the floor section that is configured to be elevated comprises at least two vehicle seat fastening elements. These or a plurality of such elements can be disposed upward from the elevated floor section but also in the transition zone to the adjoining front and/or rear floor sections.

The vehicle seat fastening elements preferably form individual pedestal sections, which are configured on their upper side for fastening seat or seat rails. The pedestal-like vehicle seat fastening elements can be fastened as separate components, for example, on the corresponding floor section, for example, welded thereto but can also be integrated in one piece in the corresponding floor section, possibly in one piece by means of a deep drawing or embossing operation.

According to an embodiment, the seat support structure comprises at least one front and one rear cross member, which are interconnected via at least one laterally disposed longitudinal member. Front and rear cross members are accordingly affixed to preferably two longitudinal members extending substantially in the vehicle longitudinal direction (x), at a distance from one another in the vehicle longitudinal direction (x). The seat cross members are thereby connected to the lateral longitudinal members of the seat support structure with their end sections lying in the vehicle transverse direction (y).

At least one of the cross members, preferably both cross members, comprise an L-shaped cross-sectional profile which is configured in each case to be open or accessible from outside facing away from the elevated floor section in the vehicle longitudinal direction. A leg of the front transverse member extending in the horizontal direction points forward, in the direction of travel, with its free end section while a correspondingly configured horizontally aligned leg of the L-shaped rear cross member points with its free end in the direction opposite the direction of travel, that is backward.

In a further embodiment, the front cross member is disposed in the transition zone between central floor section and front floor section. The rear cross member can additionally or alternatively be disposed in the transition zone between central floor section and rear floor section. The legs of the L-shaped cross members extending substantially in the vehicle vertical direction (z), that is in the vertical direction adjoin from below the elevated, preferably central floor section of the floor panel. The upper leg ends of the cross members preferably come to lie at the same height level.

According to the cross-sectional geometry of the seat cross members running below the floor panel, the floor panel has at least one sloping surface or ramp in a transition zone to the floor section configured to be elevated, which substantially coincides with the cross members in the vehicle longitudinal direction (x). Together with at least one cross member located thereunder, this forms a closed, substantially triangular cross-sectional profile. Since the floor panel is connected to the respectively adjoining profile ends of the seat cross member in its transition zone, that is in the area of or adjacent to its sloping surface(s), the particular sloping surface or ramp of the floor panel can take over a strut function which enhances the structural stiffness of the seat cross members. In particular, the leg section of the seat cross members aligned substantially in the vehicle vertical direction has a flange section formed in the horizontal direction for forming a connection with the elevated floor section of the floor panel.

According to an embodiment, the at least one cross member of the seat support structure rests on the lateral longitudinal members with its end sections lying in the vehicle transverse direction. It is advantageously further provided that at least one of the longitudinal members has an upwardly projecting tab, which in the vehicle longitudinal direction adjoins the front and/or the rear cross member and/or from below, the floor section configured to be elevated. In this way, a further structure-reinforcing connection of the longitudinal members to the elevated section of the floor panel can be achieved.

According to an embodiment, at least one of the cross members of the seat support structure is supported on an inner side of a side sill in the vehicle transverse direction. Preferably, both seat cross members come to abut against a sill inner panel with their two opposite end sections in the vehicle transverse direction (y). Here it can further be provided that the longitudinal member interconnecting the front and the rear cross members has a substantially L-shaped profile in cross-section and herewith adjoins the sill inner panel at one end and the underside of the seat cross member at the other end.

It is hereby further provided that the free end of the cross members lying in the vehicle transverse direction is substantially aligned with an exterior end section of the respectively associated longitudinal member located thereunder, relative to the vehicle transverse direction. In this way, it can be achieved that the longitudinal members and the transverse members are jointly supported on a side sill structure in the vehicle transverse direction so that the seat support structure and the side sill structure of the vehicle body can be mutually stabilized.

In a further embodiment, the floor panel is formed in one piece and comprises a central tunnel integrated in the front floor section, which opens in the vehicle longitudinal direction into the adjoining central floor section that is configured to be elevated. For this purpose, in particular the front cross member can have a curved recess for receiving and connecting the central tunnel to the cross members. An apex of the central tunnel coming to lie facing away from the front floor section in this case lies at least slightly lower than the level of the central elevated floor section.

Commonly used connecting and joining methods such as, for example spot and/or laser welding, riveting, adhesive bonding or clinching as well as similar positive and/or seamless methods should be provided for connection of the seat support structure and the floor panel, in particular, in the area of the cross and longitudinal members, and for lateral connection of the cross members to the sill structure of the automobile body.

According to further embodiment, an automobile body and an automobile are further provided, which have a previously described floor structure.

### BRIEF DESCRIPTION OF THE DRAWINGS

The present invention will hereinafter be described in conjunction with the following drawing figures, wherein like numerals denote like elements, and:

FIG. 1 shows a perspective exploded view of the floor structure;

FIG. 2 shows a perspective view of an assembled floor structure viewed from below;

FIG. 3 shows a support structure of an automobile body having the floor structure according to FIG. 2, viewed from below;

FIG. 4 shows a perspective view of the support structure according to FIG. 3 view from obliquely above;

FIG. 5 shows a cross-section along the line of intersection A-A according to FIG. 4; and

FIG. 6 shows a cross-section along B-B according to FIG. 4.

### DETAILED DESCRIPTION

The following detailed description is merely exemplary in nature and is not intended to limit application and uses. Furthermore, there is no intention to be bound by any theory presented in the preceding background or summary or the following detailed description.

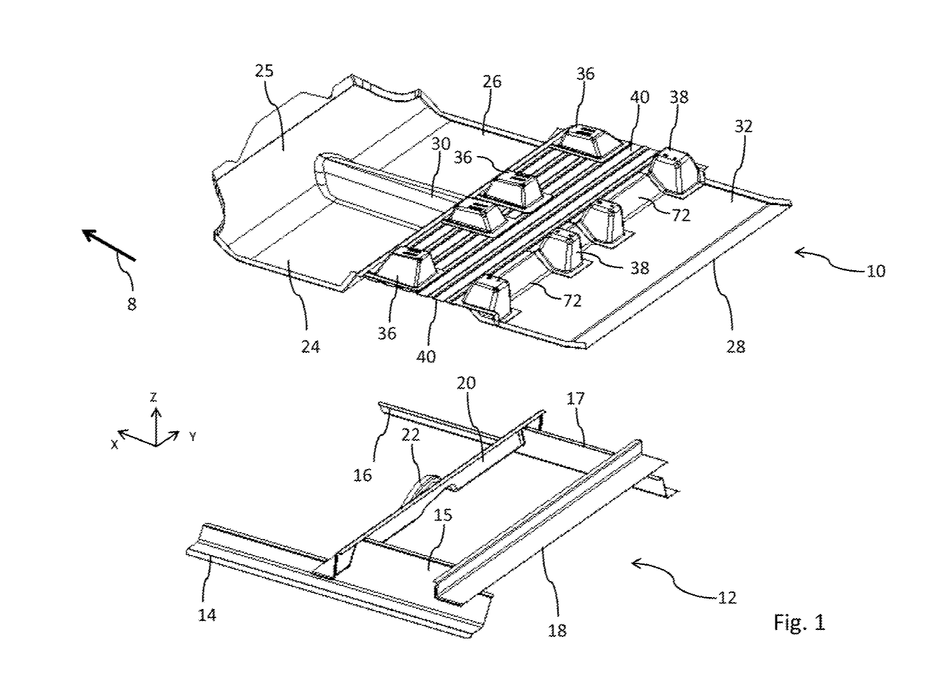

The floor structure shown isolated in perspective view in FIG. 1 comprises a one-piece floor panel 10 and a support structure 12 located thereunder. The floor panel 10 here comprises, relative to the vehicle longitudinal direction (x), three adjoining floor sections, namely a front floor section 24, 26, a central floor section 40 configured to be elevated compared to the front floor section 24, 26, and an again adjoining floor section 32 toward the rear in the direction opposite to the direction of travel 8. Although the front floor section 24, 26 comprises a left floor section 24 and a right floor section 26, these are preferably interconnected in one piece via a pedal plate section 25 mounted in front in the direction of travel 8 and via a central tunnel section 30 integrated in the floor panel 10.

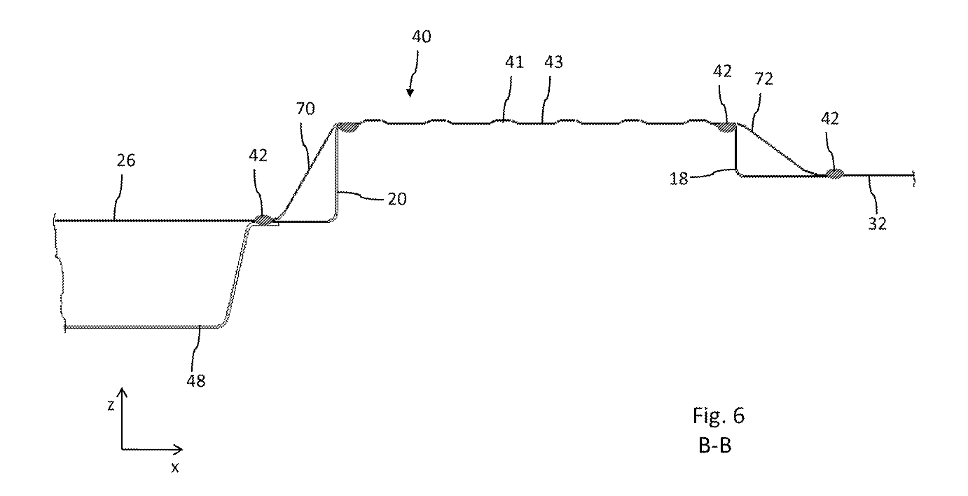

As is apparent from the cross-section according to FIG. 6, the central floor section 40 is configured to be elevated both with respect to the front floor section 26 and with respect to the rear floor section 32. This arrangement enables on the one hand an arrangement of, for example, vehicle batteries or fuel tanks below the central floor section 40. In addition, structure-reinforcing components required for the seat mounting such as, for example, a support structure 12 shown isolated in FIG. 1, comprising front and rear cross members 20, 18 can be disposed in a particularly space-saving manner below the central floor panel section 40. Individual beadings 41, 43 running in the vehicle transverse direction (y) are provided in particular in the central floor section 40 to improve the structural rigidity of the floor panel 10.

Individual seat fastening elements 36, 38 are provided on the central floor section 40, which serve to fasten and receive seats or appurtenant seat rails. The fastening elements 36, 38 configured to be approximately trapezoidal can be fastened separately as separate components on the upper side of the central floor section 40 or on an obliquely running transition section 72 between central and rear floor section 40, 32 or said pedestals can be incorporated in one piece and integrated in the floor panel 10 by means of an embossing, deep-drawing or similar forming operation.

The seat support structure 12 shown isolated in FIG. 1 and coming to lie underneath the floor panel 10 comprises two lateral longitudinal members 14, 16 extending substantially in the vehicle longitudinal direction (x), on which two cross members spaced apart from one another in the vehicle longitudinal direction (x), a front cross member 20 and a rear cross member 18, rest and are fastened. The two cross members 18, 20 and the longitudinal members 14, 16 have a substantially L-shaped cross-sectional profile.

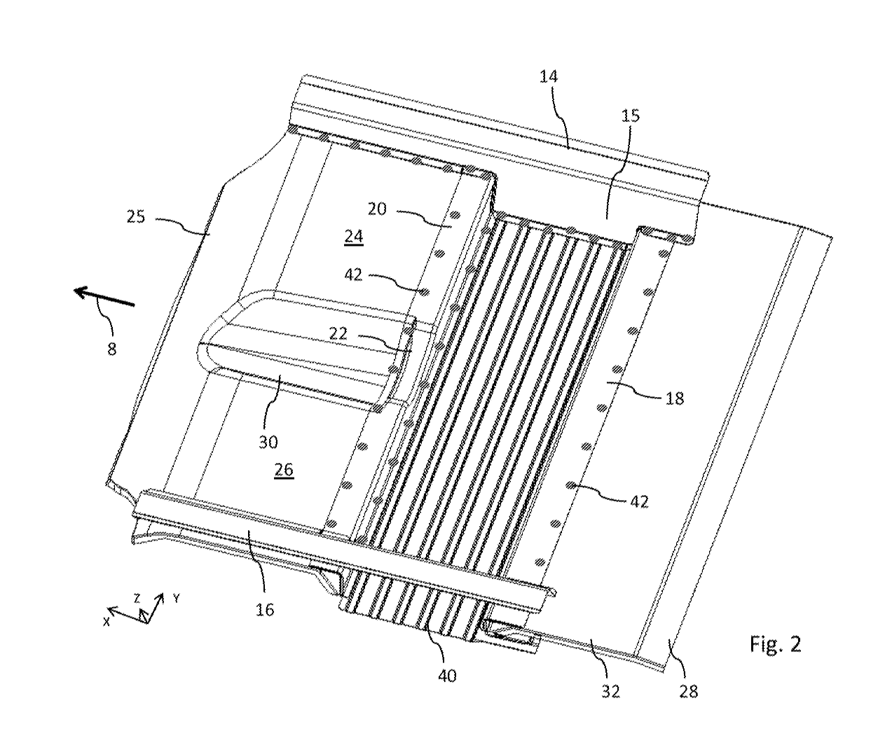

In particular, the front cross member 20 has a curved recess 22 approximately centrally between the longitudinal members 14, 16 for receiving the central tunnel 30 configured to adjoin this from the front, as is deduced from a combined view of FIG. 1 and FIG. 2. It can further be identified from the cross-sectional view according to FIG. 6 that in a final assembly configuration the front cross member 20 comes to rest in the transition zone between central floor section 40 and front floor section 24, 26 and the rear cross member 18 comes to rest in the transition zone between central floor section 40 and rear floor section 32.

As a result of the one-piece configuration of the floor panel 10 and the height offset between central, front, and rear floor section 40, 24, 26, 32, individual sloping surfaces 72, 74 are obtained in the area of the cross members 20, 18, which can provide a stabilizing function for the cross-sectional profile of the cross members 20, 18, where the floor panel 10 adjoining the respective sloping surfaces 70, 72 is in each case connected structurally to the cross members 20, 18 possibly by means of a welding operation accompanied by the formation of weld points 42 or weld seams. For this purpose the cross members 18, 20 each have an approximately horizontally running fastening flange, adjoining the floor panel 10 in the upward direction. It can further be identified in FIG. 6 that the height level of the rear floor section 32 lays above the level of the front floor section 26. Accordingly, both the central floor section 40 and also the rear floor section 32 can be configured to be free from the central tunnel and therefore substantially flat, at least when viewed in the vehicle transverse direction (y).

The two longitudinal members 14, 16 of the seat support structure 12 shown in FIG. 1 and in FIG. 2 each have an upwardly projecting tab 15, 17 in a region located between front and rear cross member 20, 18, which each adjoin in the vehicle longitudinal direction the front and/or the rear cross member 20, 18 and/or from below, the elevated floor section 40. Since the longitudinal members 14, 16 have a fastening flange at their upper end section in the vehicle vertical direction, here also a structural connection illustrated by individual weld points 42 in FIG. 2 can be formed between the upwardly projecting tabs 15, 17 of the longitudinal members 14, 16 and the elevated central floor section 40.

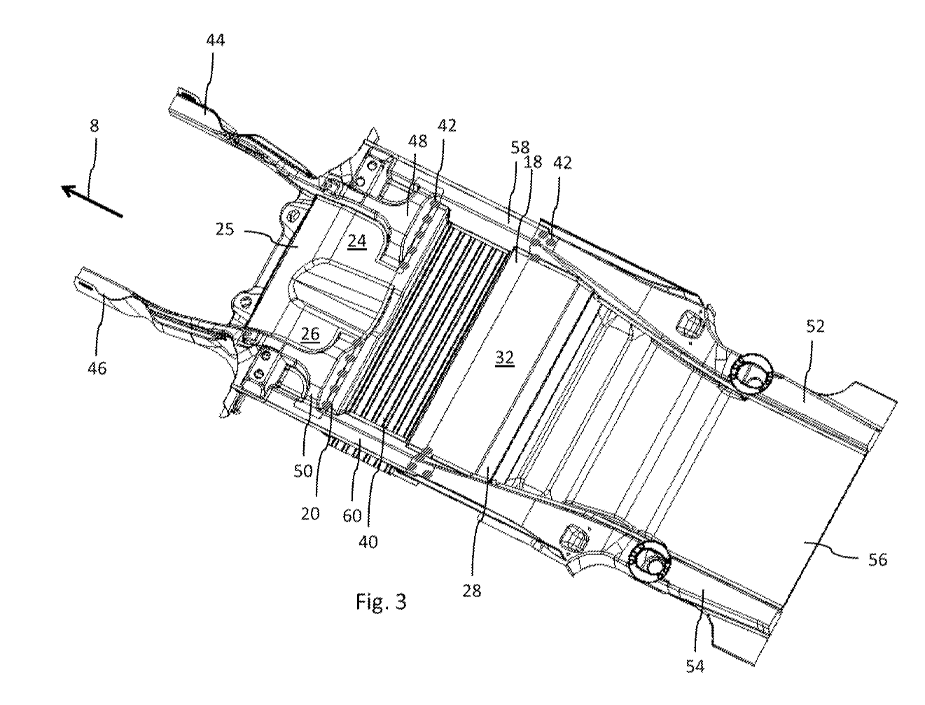

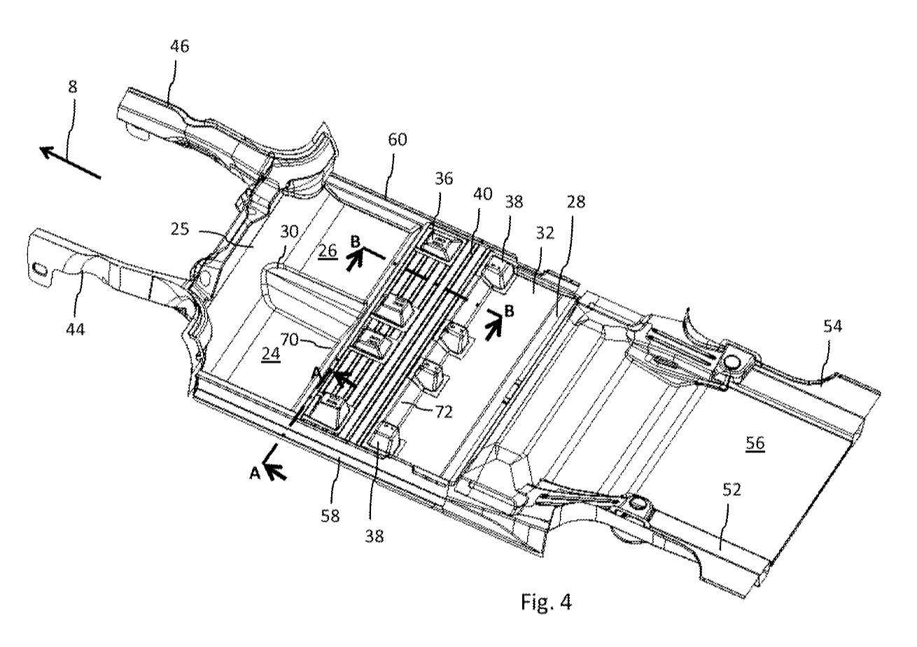

A floor-side support structure of an automobile body is shown overall in the views according to FIG. 3 and FIG. 4. The support structure here comprises two front longitudinal members 44, 46, which go over into the lateral sill structures 58, 60 in the region of a face wall not shown explicitly here via a front frame support that is not further numbered in detail. The side sills 58, 60 go over approximately at the height of a B pillar of the vehicle, not shown explicitly, into a rear frame, which in turn comprises two rear longitudinal members 52, 54 disposed in extension of the side sills 58, 60 and a rear floor 56.

Finally, a heel plate comes to lie between the rear floor 56 and the rear floor section 32 that comes to lie in an overlapping manner with a rear connecting section 28 of the rear floor section 32 in a final assembly configuration. Furthermore, it can be identified in particular in the diagram according to FIG. 3 that the front longitudinal members 44, 46 go over into a T-shaped front frame extension 48, 50 extending in the vehicle transverse direction (y). As indicated in FIG. 6, a fastening flange of the front frame extension 48, 50 here adjoins from below the transition zone between front floor section 26 and central floor section 40.

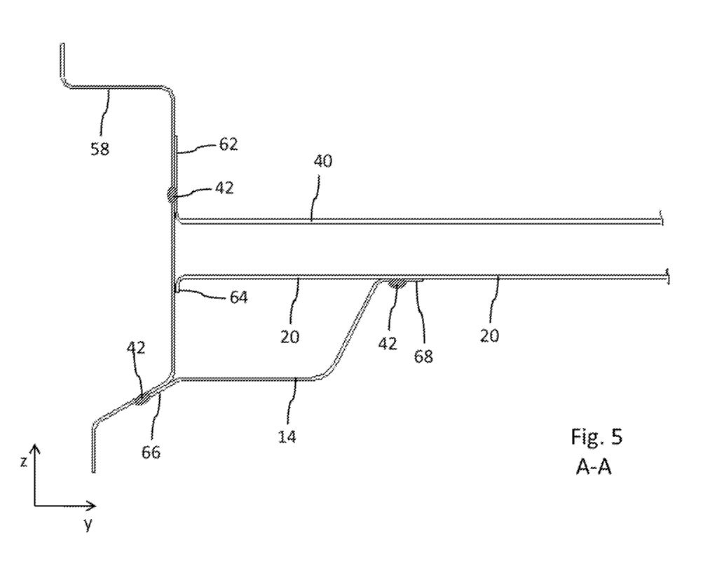

The cross-sectional view according to FIG. 5 further shows the support of the front cross member 20 on the lateral sill structure 58 and the fastening of the central floor section 40 located there above onto said structure. Toward the side adjoining the side sill 58, the floor section 40 has an upwardly projecting fastening flange 62, which is fastened to the sill structure 58 by means of a weld point 42.

The sill inner plate 58 configured as C-shaped in cross-section is further used for fastening the longitudinal member 14, which comes to abut against the sill inner plate with an outwardly and obliquely downwardly projecting fastening flange 66 and is also affixed there by means of a weld point 42. At the other end, in the upward direction facing the front cross member 20, the longitudinal member 14 has another fastening flange 68 on which the front cross member 20 comes to rest and by which means a structure-reinforcing welded connection of cross member 20 and longitudinal member 14 can be made.

The cross member 20 is furthermore supported with a downwardly projecting supporting flange 64 substantially without forming a fixed connection at the sill inner plate 58. Since both the cross members 18, 20 and also the longitudinal members 14, 16 are directly supported on the sill inner structure 58, the structural and torsional stiffness of the vehicle body as a whole can advantageously be increased. Any forces occurring in the vehicle transverse direction (y) and/or the vehicle longitudinal direction can in this way be led off directly into the stabilizing cross member 18, 20. In this respect, the seat support structure 12 also stabilizes the side sill structure 58, 60 with respect to intrusion forces acting in the vehicle transverse direction (y). When viewed overall, the seat support structure 12 formed by the two longitudinal members 14, 16 and the cross members 18, 20, provided below the floor panel 10 forms a type of structure-reinforcing ladder frame, in particular for the fastening of the automobile seats.

The embodiments depicted show merely a possible embodiment for which further numerous variants are feasible and are within the framework. The exemplary embodiments shown as examples are in no way to be interpreted as restrictive in regard to the scope, the applicability, or the possible configurations. The present description merely shows the person skilled in the art one possible implementation of an exemplary embodiment. The most diverse modifications can be made to the function and arrangement of elements described without departing from the scope of protection defined by the following patent claims or their equivalents.

What is claimed is:

1. A floor structure of an automobile body, comprising:
a floor panel comprises at least two floor sections that adjoin one another in a vehicle longitudinal direction and configured to be substantially flat, which are disposed offset with respect to one another in relation to the vehicle vertical direction; and
a seat support structure disposed underneath the floor panel, and the seat support structure comprises at least one transverse structure stabilizing a floor section at least in an area of a higher floor section.

2. The floor structure according to claim 1, wherein in relation to the vehicle longitudinal direction the floor panel comprises:
at least one floor section of the at least two front floor sections;
a central floor section; and
a rear floor section of which the central floor section is elevated with respect to the floor section in relation to the vehicle vertical direction.

3. The floor structure according to claim 2, wherein the rear floor section is elevated as compared with the two front floor sections.

4. The floor structure according to claim 1, wherein the floor section that is elevated is formed in one piece with at least additional floor section adjoining thereon in the vehicle longitudinal direction.

5. The floor structure according to claim 1, wherein the floor section that is elevated has a surface structuring that increases stability.

6. The floor structure according to claim 1, wherein the floor section that is elevated comprises at least two vehicle seat fastening elements.

7. The floor structure according to claim 1, wherein the seat support structure comprises at least one front cross member and one rear cross member that are interconnected via at least one laterally disposed longitudinal member.

8. The floor structure according to claim 7, wherein the cross members comprise an L-shaped cross-sectional profile that is configured in each case to be open facing away from an elevated floor section in the vehicle longitudinal direction.

9. The floor structure according to claim 7, wherein the front cross member is disposed in the transition zone between central floor section and front floor section.

10. The floor structure according to claim 7, wherein the one rear cross member is disposed in the transition zone between central floor section and rear floor section.

11. The floor structure according to claim 8, wherein in a transition zone to the floor section that is elevated, the floor panel has at least one sloping surface that together with at least one cross member located thereunder forms a closed, substantially triangular cross-sectional profile.

12. The floor structure according claim 7,
wherein the at least one front cross member is configured to rest on the lateral longitudinal members with end sections lying in the vehicle transverse direction, and
wherein at least one of the longitudinal members has an upwardly projecting tab that in the vehicle longitudinal direction adjoins the at least one cross member.

13. The floor structure according to claim 7, wherein at least one of the cross members of the seat support structure is supported on an inner side of a side sill in the vehicle transverse direction.

14. The floor structure according to claim 2, wherein the floor panel is formed in one piece and comprises a central tunnel integrated in the front floor section, which opens in the vehicle longitudinal direction into an adjoining floor section that is configured to be elevated.
